(19) United States
(12) Patent Application Publication
(10) Pub. No.: US 2007/0220314 A1
(43) Pub. Date: Sep. 20, 2007

(54) Backup/recovery system and methods regarding the same

(75) Inventors: George Wang, Chongqing (CN); Pei Hu Lin, Irvine, CA (US)

Correspondence Address: ARENT FOX PLLC, 1050 CONNECTICUT AVENUE, N.W., SUITE 400, WASHINGTON, DC, 20036, US

(73) Assignee: FARSTONE TECH., INC.

(21) Appl. No.: 11/493,925

(22) Filed: Jul. 27, 2006

(30) Foreign Application Priority Data
Jul. 27, 2005 (TW) 94120513

(51) Int. Cl. G06F 11/00

(52) U.S. Cl. 714/6

(57) ABSTRACT

A backup/recovery system and methodology that securely protects data in a computer system. According to the invention, in one embodiment of the invention, backup/recovery system is installed in the computer system. The backup/recovery system includes at least a backup unit, a storage means and a recovery unit. The backup unit is used for backing up data of the computer system. The storage means is used for storing the backed up data and at least one file designated in the computer system. The recovery unit is used for retrieving the stored data and recovering the computer system while preserving the designated file. The designated file won't be destroyed.

### CROSS-REFERENCE TO RELATED APPLICATION

The present application claims priority under 35 U.S.C. §119 to Taiwanese Patent Application No. 94120513, filed Jul. 27, 2005, the contents thereof incorporated by reference herein in its entirety.

### BACKGROUND OF THE INVENTION

1. Field of the Invention

The present invention relates generally to a backup/recovery technique for a computer system, and more particularly to a backup/recovery system and method that securely protects data in a computer system after the backup/recovery operation.

2. Description of Prior Art

Conventional backup/recovery software is the backup and disaster recovery solutions to prevent losing data of a hard disk after a fatal system failure. The data in the hard disk must be backed up beforehand. Users can create an image file of their hard disk. The image file contains the exact, byte-by-byte copy of the hard disk, partition or logical disk.

For example, the conventional backup/recovery software, such as the Ghost software developed by Symantec Corporation, includes a backup program to back up data stored in selected partitions of the hard disk to the image file. In addition, it further includes a recovery program for restoring the data from the image file to the selected partitions of the hard disk. Users can restore the hard disk with the backed-up data.

However, the conventional backup/recovery software has one major drawback. That is the restoration process inevitably restores all data in the entire hard disk, including files with users' personal data. For this reason, users need to rebuild such files. Current techniques available in the conventional backup/recovery software provide no notion of how to solve the problem of protection of the destroyed personal data.

### SUMMARY OF THE INVENTION

The present invention provides a backup/recovery system and method to resolve the foregoing problems faced by the conventional backup/recovery software. The present invention also has the advantage of providing a fully protection to the backup data.

An object of the present invention is to provide a backup/recovery system and method, wherein designated files can be protected in a storage means.

In accordance with an aspect of the present invention, a backup/recovery system is installed in a computer system. The recovery system comprises a backup unit, a storage means and a recovery unit. The backup unit is used for backing up data of the computer system. The storage means is used for storing the backed up data and at least one file designated in the computer system. The recovery unit is used for retrieving the stored data and recovering the computer system while preserving the designated file.

In the preferred embodiment of the invention, the backup unit includes a backup module and a file backup module, the backup module backs up hard drive data of the computer system, and the file backup module backs up the designated file. The storage means includes a backup space and a file backup space, the backup space keeps the hard drive data, and the file backup space keeps the designated file. The recovery unit includes a recovery module and a file recovery module, the recovery module recovers up the hard drive data, and the file recovery module recovers the designated file. The file recovery module recovers data of file other than the designated file, the designated file won't be destroyed. The backup space includes a network drive, a hard disk drive, a server or a network server. The file backup space includes a network drive, a hard disk drive, a server or a network server.

### BRIEF DESCRIPTION OF THE DRAWINGS

The present invention may best be understood through the following description with reference to the accompanying drawings, in which:

FIG. 1 shows a schematic block diagram of a backup/recovery system of a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for a backup/recovery system to protect user-designated files, which can be kept in a secured space. After the recovery operation, the backup/recovery system reinstates such user-designated files, so as to recover the computer system while the designated files will not be lost.

According to the preferred embodiment of the present invention, a backup/recovery system is installed in a computer system. The recovery system comprises a backup unit, a storage means and a recovery unit. The backup unit is used for backing up data of the computer system. The storage means is used for storing the backed up data and at least one file designated in the computer system. The recovery unit is used for retrieving the stored data and recovering the computer system while preserving the designated file.

The backup unit includes a backup module and a file backup module, the backup module backs up hard drive data of the computer system, and the file backup module backs up the designated file.

The storage means includes a backup space and a file backup space, the backup space keeps the hard drive data, and the file backup space keeps the designated file.

The recovery unit includes a recovery module and a file recovery module, the recovery module recovers up the hard drive data, and the file recovery module recovers the designated file.

The file recovery module recovers data of file other than the designated file, the designated file won't be destroyed.

The backup space includes a network drive, a hard disk drive, a server or a network server. The file backup space includes a network drive, a hard disk drive, a server or a network server.

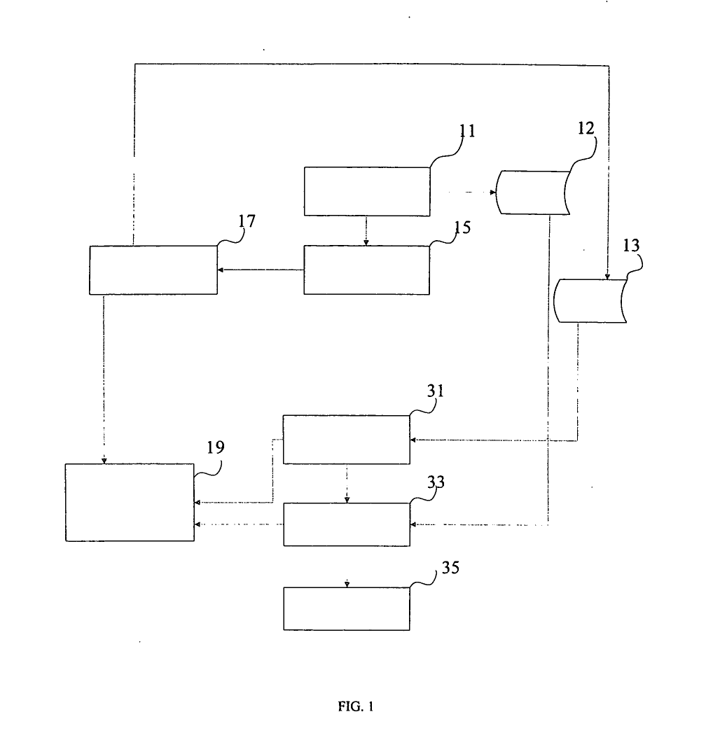

Referring to FIG. 1, a schematic block diagram of a backup/recovery system of a preferred embodiment according to the present invention is shown. The backup/recovery system of the present invention is suitable for a computer system. The backup/recovery system includes at least a backup module 17, a file backup module 11, a recovery module 31 and a file recovery module 33.

The file system 15/disk driver 19 manipulates requests of access and read/write operation, from the application program. Prior to the manipulation, the backup module 17 backs up hard drive data of the computer system into the backup space 13, and the file backup module 11 backs up file data into the file backup space 12.

The user may designate some files which are needed to be especially preserved. The file backup module 11 backs up the designated files and keeps records of create/change operation to such files, in the file backup space 12. After the backup process is completed, the file system 15 reads/writes the designated files.

The backup/recovery system allows users to manually store critical files. The backup space 13/file backup space 12 may be a hidden space or an external storage.

The recovery module 31 automatically retrieves backed up data from the backup space 13. The disk driver 19 is restoring to a previous state in accordance with the backed up data. The file recovery module 33 then automatically retrieves backed up file from the file backup space 12 in accordance with the recorded message. Hence, the designated file is preserved while the computer system is recovered. Afterwards, the computer system is restart. The OS 35 is running.

The present invention automatically retrieves user-designated files from a hidden space or an external storage. The users are free from recreating several files. While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A recovery system, which is installed in a computer system, said recovery system comprising:
a backup unit for backing up data of said computer system;
a storage means for storing said backed up data and at least one file designated in said computer system; and
a recovery unit for retrieving said stored data and recovering said computer system while preserving said designated file.

2. The recovery system according to claim 1, wherein said backup unit includes a backup module and a file backup module, said backup module backs up hard drive data of said computer system, and said file backup module backs up said designated file.

3. The recovery system according to claim 2, wherein said storage means includes a backup space and a file backup space, said backup space keeps said hard drive data, and said file backup space keeps said designated file.

4. The recovery system according to claim 2, wherein said recovery unit includes a recovery module and a file recovery module, said recovery module recovers up said hard drive data, and said file recovery module recovers said designated file.

5. The recovery system according to claim 4, wherein said file recovery module recovers data of file other than said designated file, said designated file won't be destroyed.

6. The recovery system according to claim 3, wherein said backup space includes a network drive.

7. The recovery system according to claim 3, wherein said backup space includes a hard disk drive.

8. The recovery system according to claim 3, wherein said backup space includes a server.

9. The recovery system according to claim 3, wherein said backup space includes a network server.

10. The recovery system according to claim 3, wherein said file backup space includes a network drive.

11. The recovery system according to claim 3, wherein said file backup space includes a hard disk drive.

12. The recovery system according to claim 3, wherein said file backup space includes a server.

13. The recovery system according to claim 3, wherein said file backup space includes a network server.
